(19) United States
(12) Patent Application Publication
(10) Pub. No.: US 2026/0330739 A1
(43) Pub. Date: Oct. 22, 2026

(54) DYNAMIC EXECUTION BRANCHING FOR IN-FLIGHT GENERATIVE VIDEO INFERENCE IN A NEURAL PROCESSING UNIT

(71) Applicant: Dorian Cartwright, San Jose, CA (US)

(72) Inventor: Dorian Cartwright, San Jose, CA (US)

(21) Appl. No.: 19/664,886

(22) Filed: Apr. 30, 2026

(51) Int. Cl. G06T 13/40; G06N 3/0475

(52) U.S. Cl. CPC G06T 13/40; G06N 3/0475

(57) ABSTRACT

A hardware-implemented system and method are disclosed for interruptible branch execution during continuous generative video inference in a neural processing unit (NPU). An NPU executes a generative neural network to produce successive video frames while maintaining an in-progress spatial-temporal model state in on-chip or high-bandwidth memory. During execution, an asynchronous interrupt carrying an updated multimodal conditioning input is detected. In response, the NPU suspends further dispatch of a subsequent tensor-operation group at an interrupt-safe execution boundary, snapshots the in-progress model state and execution-context metadata into dedicated state-preservation storage, and generates an updated branch context based on the updated multimodal conditioning input. The NPU selectively invalidates only downstream state portions dependent on a prior conditioning context, recomputes affected tensor operations using the updated branch context and the preserved model state, and resumes frame generation without reinitializing model weights, flushing the memory buffer, or restarting the generative pipeline. The disclosed architecture enables low-latency, real-time modification of AI-generated video output while maintaining temporal continuity and reducing recomputation overhead.

### FIELD OF THE INVENTION

The present disclosure relates generally to computers and physical artificial intelligence (AI), and more specifically, to interruptible, branch-resumable execution of generative neural networks within a neural processing unit (NPU) during continuous video generation.

### BACKGROUND

Generative artificial intelligence systems are increasingly used to synthesize continuous video streams, animated scenes, live avatars, augmented reality content, simulation environments, and other temporally evolving visual outputs. In many such systems, a neural network executes a sequence of inference operations to generate successive frames based on a current conditioning context, which may include one or more text prompts, image prompts, audio prompts, control signals, pose data, scene constraints, trajectory signals, or other multimodal inputs.

Conventional generative pipelines are generally optimized for a stable conditioning context during a given generation run. When a user, application, control system, or external device wishes to modify the generated output mid-stream, many existing systems respond by terminating the current generation process, flushing or discarding intermediate state, and initiating a new generation pass from an updated prompt or other revised input. Such restart-based approaches can introduce latency, temporal discontinuity, visual artifacts, increased memory bandwidth usage, and wasted computation.

This problem is particularly acute in live or interactive settings, such as conversational video agents, robotic telepresence systems, real-time simulation, gaming, mixed reality, live media editing, and autonomous systems requiring prompt-responsive visual rendering. In such environments, conditioning inputs may change asynchronously while a generative model is actively computing a subsequent frame or maintaining an in-progress spatial-temporal latent representation. If the system merely cancels the ongoing response or restarts a new generation pipeline, useful internal state may be lost and the user may observe visible jitter, stutter, discontinuity, or delayed responsiveness.

Existing conversational interruption mechanisms are generally directed to dialogue-level barge-in behavior, such as terminating or truncating an in-progress response stream and initiating a new response based on updated conversational input. Such mechanisms do not address how an accelerator or NPU should preserve in-flight internal generative state at a hardware execution boundary, selectively invalidate only affected downstream operations, and resume generation without full pipeline reinitialization.

Accordingly, there exists a need for an improved hardware-implemented architecture that enables a generative video model to accept asynchronous mid-generation input changes, preserve useful internal model state, and resume execution from an interrupt-safe branch point with reduced recomputation and improved temporal continuity.

### SUMMARY

These shortcomings are addressed by systems, methods and computer program products for branch-resumable execution of a generative video model within a neural processing unit (NPU). In various embodiments, an NPU executes a generative neural network to generate successive video frames while maintaining an in-progress spatial-temporal model state in on-chip memory, high-bandwidth memory, or other memory accessible to the NPU.

During execution, an asynchronous interrupt carrying an updated multimodal conditioning input may be detected. In response, execution-control logic of the NPU identifies an interrupt-safe execution boundary, such as a boundary occurring after completion of a currently issued tensor-operation group and before dispatch of a next tensor-operation group. At that boundary, the NPU suspends further dispatch, snapshots the in-progress model state and associated execution-context metadata into dedicated state-preservation storage, and generates an updated branch context from the updated conditioning input.

In various embodiments, the execution-control logic selectively invalidates only downstream state portions determined to depend on a prior conditioning context, while preserving unaffected portions of the in-progress state. The NPU then recomputes one or more downstream tensor operations affected by the updated branch context and resumes generation of subsequent video frames without reinitializing model weights, without flushing the memory buffer holding the in-progress model state, and without restarting the generative model from an initial frame state.

In certain embodiments, the disclosed architecture reduces latency associated with mid-generation prompt changes, preserves temporal continuity, reduces bandwidth consumption, lowers recomputation overhead, and improves responsiveness in interactive AI video generation systems. The disclosed techniques may be applied in video synthesis, avatar systems, robotics, simulation, mixed reality, gaming, streaming media, edge AI devices, mobile processors, and other environments involving continuously updated generative inference.

### BRIEF DESCRIPTION OF THE DRAWINGS

The present disclosure will be understood more fully from the detailed description given below and from the accompanying drawings of various embodiments of the disclosure.

FIG. 1 is a schematic block diagram illustrating an example system for branch-resumable execution of a generative video model within a NPU, according to an embodiment.

FIG. 2 is a schematic diagram illustrating an example AI video module, according to an embodiment.

FIG. 3 is a perspective diagram illustrating branch-resumable execution of a generative video model within the NPU, according to an embodiment.

FIG. 4 is a flow chart illustrating a method for continuing generative AI video streams during interrupts without reinitializing, according to an embodiment.

FIG. 5 is a flow chart illustrating a method for updating resources by execution control logic based on interrupt, according to an embodiment.

FIG. 6 is a flow chart illustrating a method for snapshotting an in-progress spatial-temporal model state at the interrupt safe boundary, according to an embodiment.

FIG. 7 is a flow chart illustrating a method for recomputing downstream tensor operations and updated in-progress spatial-temporal model state, according to an embodiment.

### DETAILED DESCRIPTION

Systems, methods, and computer program products for branch-resumable execution of a generative video model within an NPU are described more fully with reference to illustrative embodiments. The embodiments described herein are provided by way of example and not limitation. A person of ordinary skill in the art will recognize that numerous modifications, substitutions, and variations may be made without departing from the spirit and scope of the invention.

As used herein, the term “neural processing unit” (NPU) may refer to any hardware accelerator, tensor-processing device, AI inference processor, matrix engine, graphics processor configured for neural inference, system-on-chip AI engine, edge AI accelerator, or other specialized processor capable of executing neural-network operations. The term “tensor-operation group” may refer to one or more scheduled tensor operations, tiles, kernels, layer operations, attention operations, denoising steps, transformer blocks, diffusion steps, activation operations, or other computational units grouped for execution by the NPU. The term “spatial-temporal model state” may refer to any in-progress internal representation used by a generative video model, including one or more latent tensors, feature maps, temporal embeddings, motion vectors, frame-state tensors, attention state, cache state, scheduler state, or combinations thereof. The term “conditioning context” may refer to one or more inputs that influence generated output, including text, speech, image data, control tokens, user prompts, policy signals, robotic control state, environmental context, pose signals, semantic labels, scene constraints, or other multimodal information.

In contrast to conventional systems that terminate or restart a generation process upon receiving updated input, embodiments of the present invention enable branch-resumable execution from an in-flight inference state. More particularly, the NPU may suspend further dispatch at an interrupt-safe execution boundary, preserve useful internal state, generate a revised branch context, selectively invalidate only affected downstream portions of the computation, recompute those affected portions, and continue generation with reduced disruption.

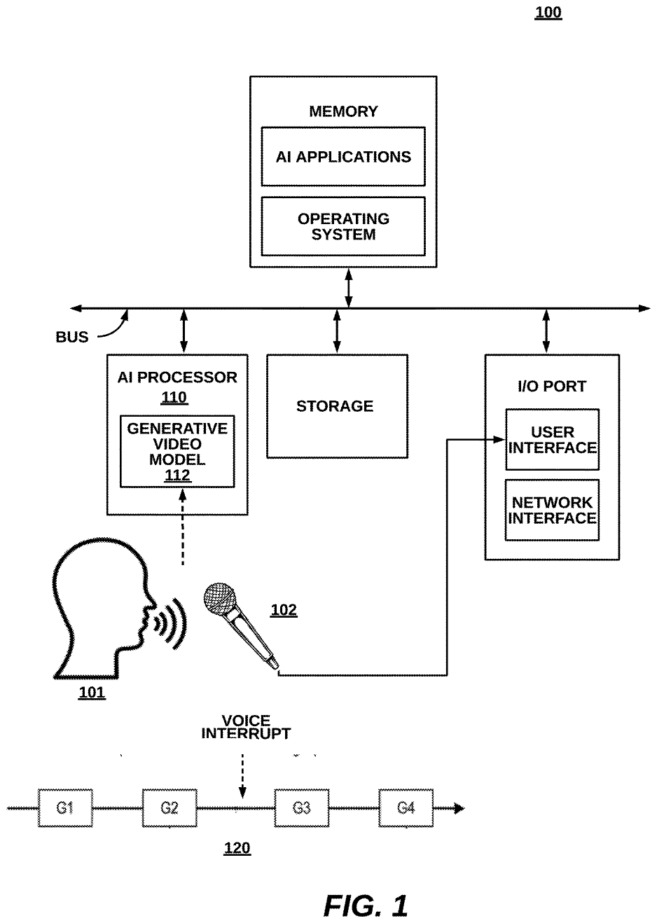

### I. Systems for Branch-Resumable Execution of a Generative Video Model (FIGS. 1-4)

Referring to FIG. 1, an example system 100 is illustrated for branch-resumable execution of a generative video model 112 within an AI processor 110, according to an embodiment. The system 100 comprises a memory, a processor, a storage, and an I/O port communicatively coupled over a bus. A user 101 gives voice feedback through a microphone 102 during tensor generation 120 (e.g., G1, G2, G3, and G4). The AI video generation can occur in a generative video model 112 located locally for edge processing or remotely at a data center for cloud processing. Video generation can be part of a live video stream, a video file creation, or video editing. Commands can be given by voice, text, image, gestures, or the like.

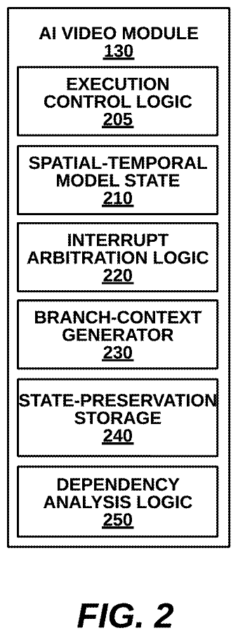

Referring to FIG. 2, an example system 100 may include an AI processor (e.g., an NPU) 110, execution-control logic 205, spatial temporal model state 210, interrupt arbitration logic 220, branch-context generator 230, state-preservation storage 240, dependency analysis logic 250, and one or more input interfaces 180.

The NPU 110 may execute a generative video model 112 to generate successive video frames. The generative video model 112 may comprise, by way of example, a transformer-based model, diffusion-based model, autoregressive model, latent video model, recurrent model, hybrid multimodal model, or any other model configured to generate temporally coherent image or video content.

Memory may include volatile memory, such as on-chip SRAM, cache memory, scratchpad memory, register files, high-bandwidth memory (HBM), unified memory, dedicated accelerator memory, or other memory structures. Memory may also include non-volatile memory or storage, including hard drives and flash memory. Memory may store model weights, in-progress spatial-temporal model state, execution queue data, and other runtime information. The NPU also includes memory.

Execution-control logic 205 may control dispatch and sequencing of tensor-operation groups to tensor cores or other processing elements of the NPU 110. Interrupt arbitration logic 220 may monitor for asynchronous interrupt events associated with updated multimodal conditioning inputs. Such interrupts may arise from user speech, controller input, application events, robotic feedback, sensor triggers, system policies, or network-delivered updates.

In one embodiment, the updated multimodal conditioning input comprises an AI-generated voice signal, synthetic narration signal, script-derived speech signal, or speech-timing signal that operates as the asynchronous interrupt for modifying a continuous generated video presentation during active inference. For example, an AI system may generate a plurality of scripts for guiding different versions of a same underlying video, scene, property walkthrough, training environment, or live media presentation. A first script may cause the continuous generated video presentation to follow a first traversal, narration path, semantic emphasis, camera path, or object-focus sequence, while a second script may cause the continuous generated video presentation to follow a different traversal, narration path, semantic emphasis, camera path, or object-focus sequence. During active generation of the video presentation, interrupt arbitration logic 220 may detect the AI-generated voice signal, synthetic narration signal, script segment, user-selected script identifier, or speech-derived control signal as an asynchronous interrupt, and branch-context generator 230 may convert the interrupt into an updated branch context for continued execution of the generative video model from a preserved in-flight spatial-temporal model state.

In a real estate tour example, a real estate website, mobile application, browser application, kiosk, or mixed-reality interface may include selectable tour controls corresponding to different AI-generated narration scripts or guided-tour modes. Selection of a control may activate a corresponding voiceover, narration path, camera path, destination sequence, room-transition sequence, or feature-emphasis sequence. The activated script or voiceover may be provided to input interface 180 as an updated multimodal conditioning input while the generative video model 112 is actively generating the walkthrough. The NPU 110 may preserve in-progress spatial-temporal model state 210, generate an updated branch context corresponding to the activated script or voiceover, selectively invalidate downstream state portions affected by the updated branch context, and resume generation so that the walkthrough continues according to the selected guided-tour mode without restarting from an initial frame state.

In some embodiments, script objects, narration-control objects, or branch-directive objects may be stored, exchanged, licensed, transmitted, or selected through a platform. Each script object may include one or more time-indexed, event-indexed, scene-indexed, or state-indexed branch directives configured to operate as asynchronous interrupts during continuous video generation. A script object may include synthetic voice data, text-to-speech input, narration timing, semantic focus identifiers, viewpoint directives, destination directives, object-emphasis directives, camera-path directives, or environmental-condition directives. When a script object is activated during active generation, the corresponding branch directives may be converted by branch-context generator 230 into updated branch contexts that modify subsequent video frames while preserving branch-independent portions of the in-progress spatial-temporal model state.

In another embodiment, a continuous generated video presentation may be used as a training, simulation, rehearsal, or curriculum-generation environment for a humanoid robot, mobile robot, autonomous vehicle, drone, wearable device, or other physical AI system. An AI-generated voice signal, script-derived control sequence, or training-regimen directive may operate as the asynchronous interrupt that changes the generated environment during active inference. For example, a training system may generate a traversal video of streets, sidewalks, building interiors, warehouses, retail spaces, or other environments, and a script-derived training directive may cause the generative video model to branch from a current traversal state toward a different route, hazard, obstacle, object, viewpoint, lighting condition, traffic condition, pedestrian condition, or semantic training focus. The NPU 110 may preserve in-progress spatial-temporal model state 210, generate an updated branch context corresponding to the training directive, selectively invalidate affected downstream state portions, and resume generation of the traversal video while preserving temporal continuity of the simulated training experience.

Branch-context generator 230 may convert an updated conditioning input into an updated branch context, such as one or more revised embeddings, conditioning vectors, token sequences, masks, temporal steering parameters, control features, or cross-attention context structures. State-preservation storage 240 may receive a snapshot of in-progress model state and associated execution-context metadata upon occurrence of an interrupt-safe execution boundary. Dependency analysis logic 250 may determine which downstream state portions depend on a prior conditioning context and should therefore be invalidated or recomputed.

### A. Interrupt-safe Execution Boundary

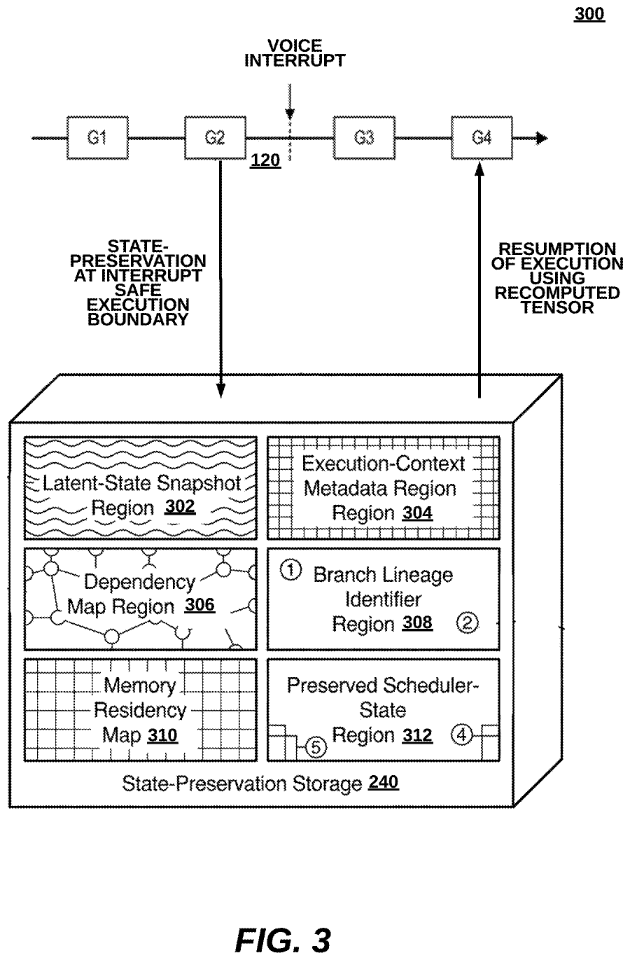

Referring to FIG. 3, the system may execute a sequence of tensor-operation groups 120 and so forth during generation of successive video frames or intermediate frame states. At some point during execution, an asynchronous interrupt (e.g., voice, text or image) may be received carrying an updated multimodal conditioning input.

Rather than immediately halting a partially issued tensor operation, the execution-control logic 205 may identify an interrupt-safe execution boundary, in this case G2. In some embodiments, the interrupt-safe execution boundary occurs after completion of a currently issued tensor-operation group and before dispatch of a next tensor-operation group, in this case G3. In other embodiments, the boundary may occur between transformer blocks, between attention heads, between denoising iterations, between frame-state update stages, at a memory-consistency barrier, or at another defined boundary that preserves correctness and avoids partial corruption of internal state.

In some embodiments, the interrupt-safe execution boundary is selected according to a boundary-selection policy that balances branch responsiveness against recomputation cost. For example, a finer-granularity boundary may allow lower interrupt latency at the cost of more frequent state preservation activity, whereas a coarser-granularity boundary may reduce preservation overhead while increasing delay before branch insertion. In some embodiments, the boundary-selection policy takes into account current frame progress, queue occupancy, model stage, estimated dependency spread, quality-of-service targets, power budget, thermal budget, or expected user-perceptible delay.

In some embodiments, multiple asynchronous interrupts may be received while a prior interrupt is pending, while a branch procedure is in progress, or while a resumed branch state remains active. Interrupt arbitration logic 220 may assign priorities, queue later interrupts, merge compatible branch requests, discard superseded branch requests, or initiate successive branch lineage states associated with respective interrupts. In some embodiments, interrupt priority may depend on user input type, safety policy, system policy, device state, application state, or predicted impact on generated output continuity.

Once the interrupt-safe execution boundary 206 is reached, dispatch of a subsequent tensor-operation group may be suspended. In some embodiments, already-issued operations are allowed to retire normally, while no additional dependent tensor groups are dispatched until state snapshotting and branch-context generation have been completed.

### B. State Snapshotting and Metadata Preservation

At the interrupt-safe execution boundary, the system may snapshot the in-progress spatial-temporal model state into state-preservation storage 240. The snapshot may include not only model-state data but also memory-location information and execution-progress information sufficient to permit precise partial recomputation and controlled resumption. By way of example, the snapshot may include one or more latent tensors, feature-map tensors, temporal history tensors, current frame index or timestep, scheduler state, attention state, key-value cache state, motion embeddings, cross-modal alignment tensors, diffusion timestep information, branch masks, dependency maps, queue state, dispatch state, execution metadata, memory offsets, residency indicators, or combinations thereof. In some embodiments, the preserved information is organized such that unaffected state portions remain resident for resumed execution while only dependency-affected portions are marked for invalidation or recomputation.

In some embodiments, the state-preservation storage operates as a dedicated preservation subsystem distinct from ordinary working buffers of the active generative pipeline. For example, the preservation subsystem may comprise a shadow buffer region, protected cache partition, dedicated high-bandwidth memory region, reserved on-chip state store, register-backed snapshot region, or other protected storage arrangement. The preservation subsystem may preserve branch-specific state, branch-independent state, valid-state indicators, lineage information, or scheduler-position information across one or more branch events. In some embodiments, the preserved information includes a memory residency map identifying locations of preserved tensors across on-chip and off-chip storage structures, thereby enabling controlled retrieval, resumption, and recomputation without full flushing of active memory.

Execution-context metadata may be stored together with the in-progress state to enable precise resumption and selective recomputation. Such metadata may identify one or more completed tensor-operation groups, currently valid state segments, portions of the model state dependent on the previous conditioning context, branch lineage identifiers, memory offsets, cache residency information, or other information useful for resuming execution.

State-preservation storage 240 may comprise a dedicated on-chip state store, shadow buffer region, protected cache partition, register-backed snapshot region, dedicated HBM page set, or another storage region reserved for branch-resumable operation. In some embodiments, the storage region may be separate from ordinary working buffers to prevent overwrite during branch computation.

Referring to FIG. 3, state-preservation storage 240 may include one or more of: a latent-state snapshot region 302; an execution-context metadata region 304; a dependency map region 306; a branch lineage identifier region 308; a memory residency map 310; and a preserved scheduler-state region 312.

The latent-state snapshot region 302 may store one or more latent tensors, temporal history structures, motion embeddings, or other model-state data. The metadata region 304 may identify which tensor-operation groups have completed, where execution will resume, and which portions of the state depend on prior context. The dependency map region 306 may store masks, graphs, tables, or tags indicating portions of state requiring invalidation upon branch insertion. The branch lineage identifier region 308 may enable versioning across multiple successive interrupts or branch events. The residency map 310 may record the location of preserved tensors within on-chip or off-chip memory structures. The preserved scheduler-state region 312 may store queue position, timestep position, frame index, and related scheduling data.

In some embodiments, the state-preservation structures of FIG. 3 may be used independently or in combination as a dedicated branch-resumable memory architecture. For example, the latent-state snapshot region 302 and memory residency map 310 may support controlled preservation of selected tensors across on-chip and off-chip memory hierarchies, while the dependency map region 306 and execution-context metadata region 304 support selective invalidation and bounded recomputation. The branch lineage identifier region 308 may associate successive branch events with corresponding preserved-state versions, and the preserved scheduler-state region 312 may enable resumed execution to recommence from a branch-aware execution position without full pipeline restart.

### C. Updated Branch Context

The updated multimodal conditioning input may take many forms. In one example, a user may verbally modify a prompt while an avatar-video model is generating a live response. In another example, a robotic operator may inject a new command, such as “show the warehouse aisle on the left,” while a generative scene model is rendering a synthetic environment, for example, in a virtual reality device or an augmented reality device. In another example, a game or simulation engine may provide an updated control token altering camera path, object semantics, or motion emphasis. In other embodiments, interrupts are suggested via any appropriate interface. In one implementation suggested interrupts are derived from current branch contexts that are already available without computation or with limited computation, and can be branched into a suggested interrupt output to the user as an option.

Branch-context generator 230 may transform the updated multimodal conditioning input 204 into an updated branch context 210. This may include generating revised text embeddings, multimodal fused embeddings, attention-control tensors, prompt masks, temporal steering vectors, cross-attention maps, or other context structures. In some embodiments, the updated branch context 210 is generated using a separate logic path, a companion processor, a smaller local model, or preprocessing circuitry before being injected into the active generative pipeline.

### D. Selective Invalidation and Recomputation

A significant feature of various embodiments is that the system need not discard the entire in-progress model state. Instead, dependency analysis logic 250 may identify downstream state portions that depend on the prior conditioning context and selectively invalidate only those portions.

For example, portions of the in-progress spatial-temporal model state that encode stable scene geometry, stable background content, persistent avatar identity, branch-independent temporal continuity, or otherwise unaffected latent components may remain valid, while only portions associated with changed semantics, changed motion constraints, changed conversational direction, changed camera-path direction, changed object emphasis, or changed control signals are marked invalid. In some embodiments, invalidation may occur at the level of tensor channels, frame regions, attention paths, latent subspaces, temporal segments, layer outputs, cache partitions, scheduled tensor-operation groups, or other dependency-addressable portions of model state. In some embodiments, invalidation decisions are generated according to rule-based logic, heuristic logic, learned logic, hybrid logic, dependency maps, lineage-aware masks, or combinations thereof.

In some embodiments, dependency analysis logic 250 determines a recomputation scope according to a tradeoff among latency, temporal continuity, compute cost, memory-bandwidth cost, and perceptual impact. For example, a first branch event may trigger recomputation of only a local semantic region, while a second branch event may trigger recomputation of a larger temporal or spatial portion if a greater context change is detected. In some embodiments, the dependency analysis logic maintains or generates one or more masks, graphs, tables, tags, lineage structures, confidence values, or priority indicators identifying which preserved state portions are to remain valid and which downstream state portions are to be invalidated or recomputed.

After invalidation, the NPU 110 may recompute one or more downstream tensor operations affected by the updated branch context 210, using the preserved state snapshot and the revised conditioning information. In some embodiments, recomputation is limited to operations downstream from the identified interrupt-safe execution boundary. In some embodiments, recomputation is further limited to dependency-marked state paths. In this manner, the system may preserve unaffected state while updating only the portions that must change in view of the new conditioning input.

Once affected downstream tensor operations have been recomputed, execution-control logic 205 may resume normal dispatch of subsequent tensor-operation groups. In preferred embodiments, the resumed execution occurs: without reinitializing model weights; without flushing memory storing the in-progress spatial-temporal model state; without restarting the generative video model from an initial frame state; and in some embodiments, without clearing attention cache structures or scheduler state unrelated to the updated branch context.

This branch-resumable approach can reduce latency compared to full restart. It can also improve temporal continuity because the generation process retains useful internal state rather than discarding all prior progress.

### E. Example Use Environments

### 1. Conversational or Avatar Video Systems

In one embodiment, the disclosed techniques may be used in a live avatar or conversational video system in which a client computing device presents a continuous generated video presentation of an artificial intelligence avatar to a user while the user engages in an ongoing spoken or multimodal conversation. The avatar may comprise a human-like character, stylized assistant, customer-service representative, tutor, simulated host, or other video-based artificial intelligence character configured to present synchronized speech, facial expression, gaze direction, head movement, body pose, gesture, or other visually observable conversational behavior. During active presentation of the continuous generated video presentation, the user may provide updated spoken input, text input, gesture input, or other conversational input directed to the avatar. Rather than terminating the active presentation and restarting video generation from an initial frame state, the system may preserve in-flight spatial-temporal model state, determine an updated conversational directive, recompute only affected downstream portions of the generative pipeline, and continue the generated video presentation with preserved continuity of avatar identity, temporal flow, and scene coherence.

In some embodiments, the avatar system maintains a persistent dialogue state, persona state, emotional state, or session state across multiple successive spoken inputs received while the continuous generated video presentation remains active. For example, the avatar may preserve a same visual identity, voice identity, emotional tone, conversational role, or scene context while responsively changing one or more of mouth movement, viseme timing, facial expression, gaze direction, posture, hand gesture, body pose, or semantic response content in view of newly received user input. In certain embodiments, the system processes successive conversational interruptions without forcing a full restart of an output-generation session, thereby allowing more natural turn-taking and reduced perceptible interruption during live interaction.

In some embodiments, the conversational avatar is provided through a mobile application, web browser, kiosk, mixed-reality headset, customer-support console, telepresence platform, educational platform, or therapeutic/wellness interface. The responsive video avatar may be rendered locally, at an edge device, or by a remote compute service in communication with the client device. The disclosed branch-resumable execution may be particularly useful where the user expects continuous visual feedback from the avatar while spoken input changes arrive during active rendering, because the system may preserve continuity of the visual presentation without discarding all prior generative progress.

### 2. Robotics and Teleoperation

In another embodiment, a robot or telepresence system may use a generative visual model to synthesize visual predictive overlays, environment reconstructions, or interactive display content. While the visual generation pipeline is in progress, sensor updates or operator commands may arrive asynchronously. The disclosed branch-resumable execution may allow the system to revise the rendering trajectory mid-stream without discarding all model state.

### 3. Mixed Reality, Gaming, and Simulation

In additional embodiments, mixed reality, gaming, or simulation systems may use the disclosed architecture to alter generated scenes, narrative elements, environmental effects, or motion trajectories in response to user actions, game-engine events, or network inputs. By preserving useful internal state and recomputing only affected portions, the system may reduce perceived lag and maintain coherence across generated frames.

### 4. Edge and Mobile Devices

In certain embodiments, the techniques herein may be implemented in mobile processors, edge AI devices, embedded systems, autonomous platforms, or other resource-constrained hardware environments. Because restart-based generation can be costly in terms of memory bandwidth and energy consumption, the disclosed architecture may provide particular benefits for on-device AI video generation where low latency and efficient state reuse are important.

In some embodiments, the branch-resumable architecture is used to reduce energy consumption, reduce memory-bandwidth usage, reduce thermal load, or improve responsiveness on resource-constrained devices that perform or participate in AI video generation. For example, a mobile device, edge device, embedded device, or wearable platform may avoid repeated flushing and full regeneration of visual output by preserving in-progress state and recomputing only dependency-affected portions in response to updated spoken input or control input. In some embodiments, a client device locally presents a responsive conversational avatar or interactive generated environment while branch-resumable operations are carried out locally, at an edge processor, or through a cooperating remote processor.

### 5. Interactive Spatial Exploration of Generated Environments

In another embodiment, the disclosed techniques may be used in an interactive environment-exploration system in which a client device displays a continuous generated video presentation of an environment and receives user input requesting changes in traversal, viewpoint, destination, or semantic focus within the environment. The environment may comprise, without limitation, a real estate property, hospitality venue, retail showroom, travel destination, museum, digital twin, simulation environment, architectural visualization, training environment, or synthetic scene. During active display of the continuous generated video presentation, a user may provide spoken or other multimodal input such as “show the kitchen,” “move to the exterior patio,” “focus on the fireplace,” “turn left,” “go upstairs,” or “zoom in on the display shelf.” In response, the system may determine an updated exploration directive, preserve in-flight spatial-temporal model state, and continue the generated presentation according to the updated exploration directive while preserving visual continuity.

In some embodiments, the environment-exploration system maintains a spatial representation, viewpoint-transition representation, room-transition representation, camera-path representation, object-focus representation, or other traversal-related representation associated with the generated environment. The updated exploration directive may correspond to a requested change in camera path, navigation direction, destination region, object emphasis, or semantic focus. In some embodiments, stable scene geometry, stable background content, or unaffected temporal continuity information may be preserved while only changed downstream portions are recomputed. In this manner, the disclosed techniques may support interactive guided exploration of generated environments without forcing a complete restart of the generative pipeline each time the user issues a new command.

In one example, the environment comprises a real estate property represented as a continuously generated interior and/or exterior walkthrough. A user may request traversal to a room, amenity, fixture, structural feature, or outdoor area, and the system may update the generated video presentation to reflect the requested traversal while preserving temporal continuity of the ongoing walkthrough. In some embodiments, the updated exploration directive may correspond to a room transition, interior-to-exterior transition, destination within the property, or semantic emphasis on a property feature. Although real estate is one useful example, the same branch-resumable techniques may be applied to many other categories of generated-environment exploration.

Many other variations are possible.

### F. Transferable Interrupt-Resumption Packages and In-Flight Migration

In some embodiments, the preserved in-progress spatial-temporal model state and execution-context metadata may be organized into a transferable interrupt-resumption package for continuing generative video inference on a different execution resource. The different execution resource may comprise another neural processing unit, a graphics processing unit, an AI accelerator, an edge device, a mobile device, a robot-local processor, a cloud server, a data-center tier, a compute-dense accelerator cluster, a memory-centric accelerator cluster, or a persistence-oriented accelerator cluster.

In one embodiment, the transferable interrupt-resumption package includes a shared-prefix reusable video-inference state corresponding to model state generated before receipt of the asynchronous interrupt, one or more branch-specific suffix state portions corresponding to state generated or designated after receipt of the asynchronous interrupt, an updated branch context, a dependency map, a branch lineage identifier, a memory residency map, scheduler-state information, frame-index or timestep information, cache-state information, model-version information, and compatibility metadata.

In some embodiments, execution-control logic, an AI agent, a branch controller, or a serving orchestrator determines whether an interrupted video-generation branch should continue on a current local NPU, be transferred to an edge execution resource, or be promoted to a remote cloud or data-center execution resource. The determination may be based on latency budget, local memory pressure, thermal condition, battery condition, network condition, expected recomputation cost, branch value, output-quality requirement, model compatibility, privacy policy, training priority, or availability of remote generative-video resources.

In one example, a user voice interrupt, AI-generated voice interrupt, script-derived interrupt, robot-generated interrupt, or application-generated branch directive is received while a continuous generated video presentation is being produced locally on a client device or robot-local processor. The system snapshots the current spatial-temporal video state at an interrupt-safe execution boundary, forms the transferable interrupt-resumption package, transmits the package to an edge or cloud execution resource, reconstructs a branch-consistent inference state at the receiving resource, and resumes generation of subsequent video frames from the transferred state without restarting the generative video model from an initial frame state.

In some embodiments, the receiving execution resource continues inference by referencing or reconstructing the shared-prefix reusable video-inference state and separately applying branch-specific suffix state corresponding to the updated branch context. In this manner, an interrupted generative video stream may migrate in-flight between local, edge, and cloud resources while preserving temporal continuity, branch identity, and reusable inference state.

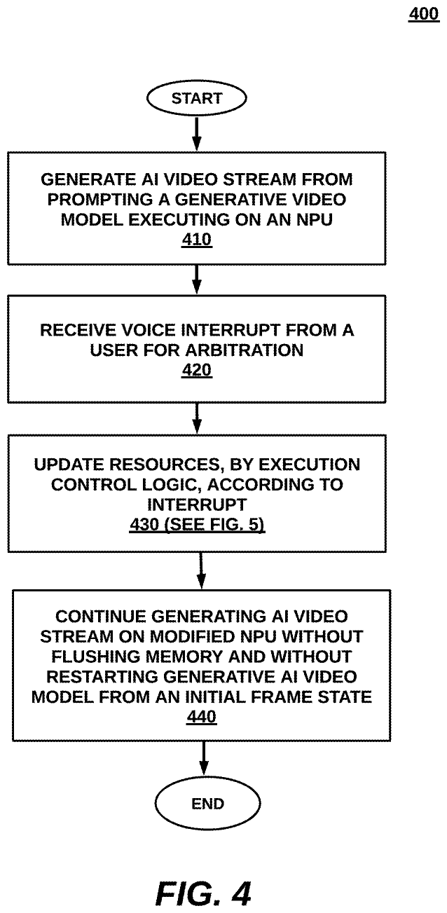

### II. Methods for Branch-Resumable Execution of a Generative Video Model (FIGS. 4-7)

The following methods describe example operations for continuing a generative AI video stream in response to an interrupt without flushing memory and without restarting the generative video model from an initial frame state. Although the methods are described with reference to FIGS. 4-7, the steps may be performed in different orders, combined, repeated, omitted, or distributed among different processing components. The steps may be implemented in hardware, firmware, software, or any suitable combination thereof.

### A. Continuing a Generative AI Video Stream During an Interrupt

Referring to FIG. 4, a method 400 illustrates a high-level process for continuing a generative AI video stream during an interrupt without reinitializing the generative video model.

At step 410, an AI video stream is generated from prompting a generative video model executing on an NPU. The generative video model may generate successive video frames, latent frame states, scene updates, avatar motion, traversal video, or other temporally linked visual output while maintaining an in-progress spatial-temporal model state associated with a current conditioning context. In some embodiments, the generative video model is executing locally on an edge device, robot-local processor, mobile device, or mixed-reality device. In other embodiments, the generative video model is executing remotely, or in cooperation with a remote execution resource.

At step 420, a voice interrupt is received from a user for arbitration. The voice interrupt may comprise spoken input, an AI-generated voice signal, a synthetic narration signal, a script-derived speech signal, a robot-generated voice signal, or another speech-derived control signal. In other embodiments, the interrupt may comprise text input, image input, gesture input, sensor-derived input, application-generated control data, robotic feedback, training feedback, or another updated multimodal conditioning input. The interrupt may be received while the generative video model is actively producing the AI video stream.

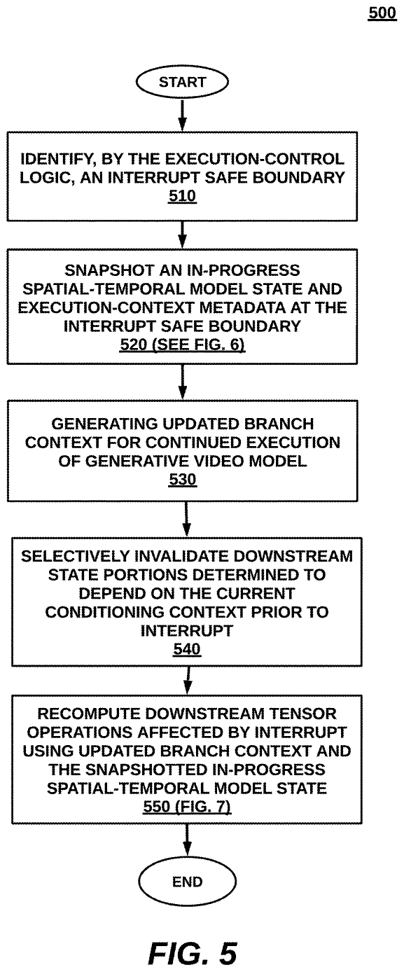

At step 430, resources are updated by execution-control logic according to the interrupt. In some embodiments, updating resources includes identifying an interrupt-safe execution boundary, snapshotting an in-progress spatial-temporal model state, generating an updated branch context, selectively invalidating affected downstream state portions, and recomputing affected downstream tensor operations. An example implementation of step 430 is described below with reference to FIG. 5.

At step 440, the AI video stream continues to be generated on the modified NPU execution state without flushing memory and without restarting the generative AI video model from an initial frame state. In some embodiments, the continued video stream preserves temporal continuity, scene continuity, avatar identity, camera-path continuity, branch lineage, or other branch-independent state while reflecting the updated branch context introduced by the interrupt.

### B. Updating Resources Based on an Interrupt

Referring to FIG. 5, a method 500 illustrates an example process for updating resources by execution-control logic according to the interrupt, as generally represented by step 430 of FIG. 4.

At step 510, the execution-control logic identifies an interrupt-safe boundary. The interrupt-safe boundary may occur after completion of a currently issued tensor-operation group and before dispatch of a next tensor-operation group. In other embodiments, the interrupt-safe boundary may occur between transformer blocks, between denoising steps, between attention operations, between frame-state update stages, at a memory-consistency barrier, or at another boundary that permits preservation of a valid in-progress model state. The execution-control logic may select the interrupt-safe boundary based on latency, recomputation cost, current frame progress, queue occupancy, model stage, dependency spread, quality-of-service target, power budget, thermal budget, or expected user-perceptible delay.

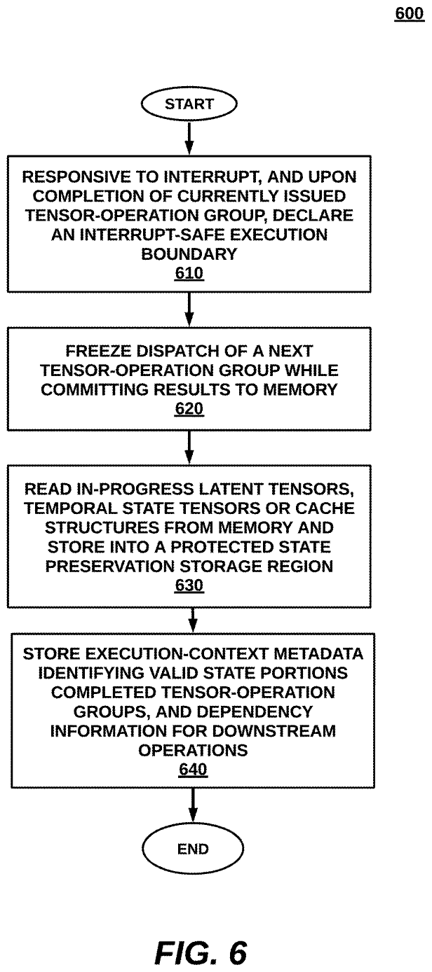

At step 520, an in-progress spatial-temporal model state and execution-context metadata are snapshotted at the interrupt-safe boundary. The snapshotting may preserve latent tensors, feature-map tensors, temporal history tensors, frame-state tensors, attention state, key-value cache state, scheduler state, motion embeddings, cross-modal alignment tensors, diffusion timestep information, branch masks, dependency maps, memory offsets, residency information, queue state, or dispatch state. A more detailed example of step 520 is described below with reference to FIG. 6.

At step 530, an updated branch context is generated for continued execution of the generative video model. The updated branch context may be generated from the voice interrupt or other updated multimodal conditioning input. The updated branch context may comprise one or more revised embeddings, conditioning vectors, token sequences, masks, temporal steering parameters, control features, camera-path parameters, semantic-focus parameters, or cross-attention context structures. In some embodiments, the updated branch context is generated by a branch-context generator, companion processor, smaller local model, preprocessing circuit, or software module.

At step 540, downstream state portions determined to depend on the current conditioning context prior to the interrupt are selectively invalidated. In some embodiments, the selectively invalidated portions include tensor channels, frame regions, attention paths, latent subspaces, temporal segments, layer outputs, cache partitions, scheduled tensor-operation groups, or other dependency-addressable portions of the in-progress state. State portions corresponding to stable scene content, stable geometry, persistent avatar identity, branch-independent temporal continuity, or other unaffected latent components may remain valid.

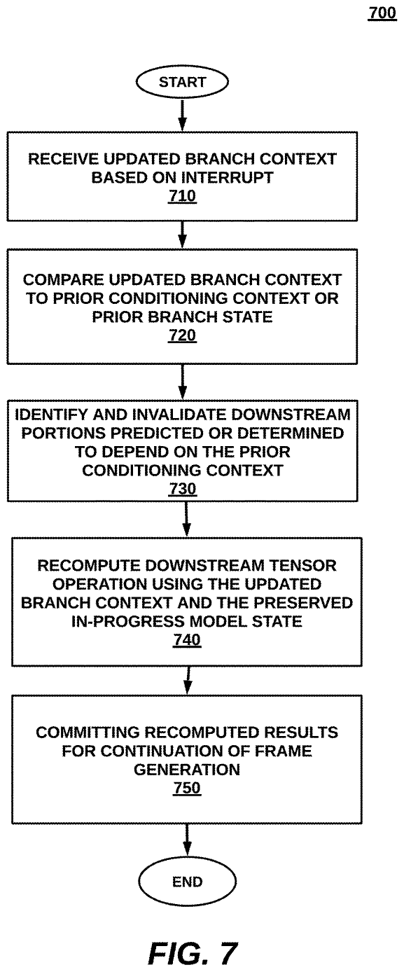

At step 550, downstream tensor operations affected by the interrupt are recomputed using the updated branch context and the snapshotted in-progress spatial-temporal model state. In some embodiments, recomputation is limited to operations downstream from the interrupt-safe boundary. In further embodiments, recomputation is further limited to dependency-marked state paths rather than an entirety of the generative model. A more detailed example of step 550 is described below with reference to FIG. 7.

After step 550, execution may return to step 440 of FIG. 4, where the AI video stream continues using the recomputed tensor results and preserved state.

### C. Snapshotting an In-Progress Spatial-Temporal Model State

Referring to FIG. 6, a method 600 illustrates an example process for snapshotting an in-progress spatial-temporal model state at an interrupt-safe boundary, as may be performed in connection with step 520 of FIG. 5.

At step 610, responsive to the interrupt and upon completion of a currently issued tensor-operation group, an interrupt-safe execution boundary is declared. In some embodiments, the execution-control logic monitors an active inference schedule and determines whether the currently issued tensor-operation group has reached a completion state. Once the group has completed, the system declares the interrupt-safe execution boundary before dispatching a next tensor-operation group.

At step 620, dispatch of a next tensor-operation group is frozen while completed results are committed to memory. In some embodiments, already-issued operations are allowed to retire normally, while no additional dependent tensor-operation groups are dispatched until state preservation has been completed.

At step 630, one or more in-progress latent tensors, temporal state tensors, or cache structures are read from memory and stored into a protected state-preservation storage region. The protected state-preservation storage region may comprise an on-chip state store, shadow buffer region, protected cache partition, register-backed snapshot region, dedicated HBM page set, or other storage region reserved for branch-resumable operation.

At step 640, execution-context metadata is stored. The execution-context metadata may identify valid state portions, completed tensor-operation groups, dependency information for downstream operations, branch lineage identifiers, frame index information, timestep information, memory offsets, cache residency information, scheduler state, or other information useful for resuming execution without restarting the generative video model from an initial frame state.

### D. Recomputing Downstream Tensor Operations

Referring to FIG. 7, a method 700 illustrates an example process for recomputing downstream tensor operations using an updated branch context and a preserved in-progress model state, as may be performed in connection with step 550 of FIG. 5.

At step 710, an updated branch context is received based on the interrupt. The updated branch context may be generated from a voice interrupt, AI-generated voice signal, script-derived control signal, robot-generated interrupt, user-selected branch directive, sensor-derived signal, or other updated multimodal conditioning input.

At step 720, the updated branch context is compared to a prior conditioning context or prior branch state. The comparison may identify changed semantic content, changed motion constraints, changed narration path, changed camera path, changed object focus, changed traversal directive, changed environmental condition, changed training directive, or other differences between the prior conditioning context and the updated branch context.

At step 730, downstream portions predicted or determined to depend on the prior conditioning context are identified and invalidated. In some embodiments, dependency analysis logic identifies affected downstream state portions using masks, graphs, tables, tags, lineage structures, confidence values, priority indicators, learned logic, rule-based logic, heuristic logic, or hybrid logic. The identified portions may be marked invalid while unaffected state portions remain valid for continued execution.

At step 740, downstream tensor operations are recomputed using the updated branch context and the preserved in-progress model state. The recomputation may be limited to dependency-marked state paths, downstream tensor-operation groups, affected latent subspaces, affected attention paths, affected temporal segments, or other selected portions of the generative model. In some embodiments, the recomputation uses the snapshotted state from the state-preservation storage region rather than reconstructing the entire model state from an initial frame state.

At step 750, recomputed results are committed for continuation of frame generation. In some embodiments, the recomputed results are merged with preserved valid state portions using masks, attention controls, blending functions, gating functions, lineage identifiers, scheduler-state information, or other commit logic. After the recomputed results are committed, the generative video model continues generating subsequent video frames without flushing memory, without reinitializing model weights, and without restarting from an initial frame state.

### III. Generalities

Various modifications may be made without departing from the scope of the disclosure. By way of example: the interrupt-safe boundary may occur at different granularities; the state-preservation storage may be implemented using different memory types; the dependency analysis may be heuristic, learned, rule-based, or hybrid; the updated conditioning input may be text, speech, image, sensor data, control data, or any combination thereof; the model may generate full video frames, latent frame states, scene updates, pose trajectories, or any other temporally linked visual representation; the branch-resumable mechanism may support multiple successive interrupts and branch chains; the resumed execution may merge preserved and recomputed state portions using masks, attention controls, blending functions, gating functions, or other commit logic.

In some embodiments, a non-transitory computer-readable medium stores instructions that, when executed by one or more processors or controllers, cause performance of any of the operations described herein.

The foregoing description of embodiments of the present disclosure has been presented for purposes of illustration and description and is not intended to be exhaustive or to limit the disclosure to the precise forms disclosed. Many modifications, variations, and alternative implementations will be apparent to those of ordinary skill in the art in light of the above teachings. For example, the disclosed branch-resumable techniques may be applied to different model architectures, processor types, memory hierarchies, state-preservation arrangements, dependency-analysis approaches, execution-boundary policies, and use environments, while preserving the core relationship among interrupt-aware execution control, preservation of in-progress model state, selective downstream invalidation, partial recomputation, and resumed generation without full restart.

Therefore, the scope of the invention is defined by the appended claims and their equivalents, rather than by the specific embodiments described herein.

I claim:

1. A hardware-implemented method for branch-resumable execution of a generative video model within a neural processing unit (NPU), the method comprising:
executing, by the NPU, the generative video model to generate successive video frames, including maintaining, in memory accessible to the NPU, an in-progress spatial-temporal model state associated with a current conditioning context;
detecting, during execution of the generative video model, an asynchronous interrupt carrying an updated multimodal conditioning input for modification of subsequently generated video frames;
identifying, by execution-control logic of the NPU, an interrupt-safe execution boundary occurring after completion of a currently issued tensor-operation group and before dispatch of a next tensor-operation group;
snapshotting, into dedicated state-preservation storage, the in-progress spatial-temporal model state and execution-context metadata associated with the generative video model at the interrupt-safe execution boundary;
generating, from the updated multimodal conditioning input, an updated branch context for continued execution of the generative video model;
selectively invalidating, by the execution-control logic, only one or more downstream state portions determined to depend on the current conditioning context prior to the updated multimodal conditioning input;
recomputing, by the NPU, one or more downstream tensor operations affected by the updated multimodal conditioning input using the updated branch context and the snapshotted in-progress spatial-temporal model state; and
resuming execution of the generative video model to generate at least one subsequent video frame using results of the recomputing,
wherein the resuming is performed without reinitializing the generative video model.

2. The method of claim 1, wherein the in-progress spatial-temporal model state comprises at least one of a latent tensor, a feature-map tensor, a temporal history tensor, a motion embedding, an attention-state structure, a key-value cache structure, a scheduler-state structure, or a frame-state tensor.

3. The method of claim 1, wherein the interrupt-safe execution boundary occurs between transformer blocks, between denoising steps, between frame-state update stages, or at a memory-consistency barrier within an inference schedule of the NPU.

4. The method of claim 1, wherein the dedicated state-preservation storage comprises an on-chip state store, a shadow buffer region, a protected cache partition, a register-backed snapshot region, or a dedicated high-bandwidth memory region.

5. The method of claim 1, wherein the execution-context metadata identifies one or more completed tensor-operation groups, one or more valid state portions, one or more dependency-marked downstream state portions, a frame index, a timestep index, or a branch lineage identifier.

6. The method of claim 1, wherein generating the updated branch context comprises generating one or more revised embeddings, attention-control tensors, prompt masks, temporal steering vectors, or fused multimodal context representations based on the updated multimodal conditioning input.

7. The method of claim 1, wherein selectively invalidating only one or more downstream state portions comprises preserving one or more unaffected state portions corresponding to stable scene content, stable temporal continuity information, or branch-independent latent components.

8. The method of claim 1, wherein the updated multimodal conditioning input comprises at least one of speech input, text input, image input, controller input, sensor-derived input, robotic control input, environmental context input, or application-generated control data.

9. The method of claim 1, wherein recomputing one or more downstream tensor operations comprises recomputing less than an entirety of tensor operations that would be recomputed in a full restart of the generative video model.

10. The method of claim 1, wherein the generative video model is configured for at least one of live avatar generation, conversational video generation, scene synthesis, simulation rendering, robotic visualization, mixed reality rendering, or gaming content generation.

11. The method of claim 1, further comprising storing, in association with the snapshotting, a dependency map identifying state portions requiring invalidation upon insertion of the updated branch context.

12. The method of claim 1, wherein multiple asynchronous interrupts are processed successively, and wherein the execution-context metadata includes a branch lineage identifier for tracking successive branch states.

13. The method of claim 1, wherein resuming execution further comprises maintaining residency of model weights in memory and preserving at least a portion of scheduler state unrelated to the updated multimodal conditioning input.

14. The method of claim 1, further comprising: responsive to detecting the interrupt, suspending dispatch of the next tensor-operation group at the interrupt-safe execution boundary.

15. The method of claim 1, wherein the updated multimodal conditioning input is received from a conversational interface during continuous video generation of an AI agent, and wherein the method preserves the in-progress spatial-temporal model state rather than canceling and restarting an output-generation session.

16. A method for providing a responsive conversational video avatar, comprising:
displaying, via a user interface, a continuous generative video stream comprising a video-based artificial intelligence character, wherein the continuous generative video stream depicts ongoing facial movement and expression;
detecting, during the displaying of the continuous generative video stream, an asynchronous interrupt comprising a spoken input from a user;
transmitting the asynchronous interrupt to a neural processing unit executing a generative video model; and
receiving and outputting an updated continuous generative video stream responsive to the spoken input, wherein the updated continuous generative video stream is generated by preserving an in-flight spatial-temporal model state, injecting the spoken input as a revised conditioning input, and recomputing only affected downstream operations without discarding all prior progress and without restarting a video generation process.

17. A system for branch-resumable execution of a generative video model with in-flight migration, comprising:
a first execution resource comprising a first artificial intelligence processor and first memory;
a second execution resource comprising a second artificial intelligence processor and second memory, wherein the second execution resource is remote from the first execution resource;
execution-control logic configured to:
execute, at the first execution resource, a generative video model to generate successive video frames while maintaining, in the first memory, an in-progress spatial-temporal model state associated with a current conditioning context;
detect, during execution of the generative video model at the first execution resource, an asynchronous interrupt carrying an updated multimodal conditioning input for modification of subsequently generated video frames;
identify an interrupt-safe execution boundary occurring after completion of a currently issued tensor-operation group and before dispatch of a next tensor-operation group;
snapshot, at the interrupt-safe execution boundary, the in-progress spatial-temporal model state and execution-context metadata associated with the generative video model;
generate, from the updated multimodal conditioning input, an updated branch context for continued execution of the generative video model;
form an interrupt-resumption package comprising at least the snapshotted in-progress spatial-temporal model state, the execution-context metadata, the updated branch context, and a branch lineage identifier;
select the second execution resource for continued execution of the generative video model based on at least one of latency, memory pressure, thermal condition, battery condition, network condition, model compatibility, privacy policy, expected recomputation cost, branch value, or output-quality requirement;
transmit the interrupt-resumption package from the first execution resource to the second execution resource;
reconstruct, at the second execution resource, a branch-consistent inference state using the interrupt-resumption package; and
continue execution of the generative video model at the second execution resource to generate at least one subsequent video frame without restarting the generative video model from an initial frame state.

18. The system of claim 17, wherein the first execution resource comprises an edge device and the second execution resource comprises a cloud server, data-center tier, compute-dense accelerator cluster, memory-centric accelerator cluster, or persistence-oriented accelerator cluster.

19. The system of claim 17, wherein the first execution resource comprises a cloud server or data-center tier and the second execution resource comprises an edge device, mobile device, mixed-reality device, robot-local processor, vehicle processor, or client computing device.

20. The system of claim 17, wherein the interrupt-resumption package further comprises a shared-prefix reusable video-inference state corresponding to model state generated before receipt of the asynchronous interrupt and one or more branch-specific suffix state portions corresponding to state generated or designated after receipt of the asynchronous interrupt, and wherein the second execution resource continues execution by referencing or reconstructing the shared-prefix reusable video-inference state and applying the one or more branch-specific suffix state portions without recomputing an entirety of the shared-prefix reusable video-inference state.
